(19) United States
(12) Patent Application Publication
(10) Pub. No.: US 2026/0296481 A1
(43) Pub. Date: Oct. 1, 2026

(54) DUAL CONTROL FOR AUTONOMOUS MERGING WITH MODEL-BASED DIFFUSION

(71) Applicant: Honda Motor Co., Ltd., Tokyo (JP)

(72) Inventors: Jovin Jeevan D'SA, Ann Arbor, MI (US); Behdad CHALAKI, Ann Arbor, MI (US); Tyler Robert NAES, Farmington, MI (US); Hossein NOURKHIZ MAHJOUB, Ann Arbor, MI (US); Ehsan MORADI-PARI, Ann Arbor, MI (US); Jacob Wesley KNAUP, Atlanta, GA (US)

(73) Assignee: Honda Motor Co., Ltd., Tokyo (JP)

(21) Appl. No.: 19/079,088

(22) Filed: Mar. 13, 2025

Related U.S. Application Data
(60) Provisional application No. 63/712,828, filed on Oct. 28, 2024.

(51) Int. Cl. B60W 60/00; B60W 50/00; G06N 7/01

(52) U.S. Cl. CPC B60W 60/001; B60W 50/0097; G06N 7/01; B60W 2556/10

(57) ABSTRACT

A method of active learning to derive predicted belief distributions for autonomous driving may provide a control policy to reduce an optimality gap between a model predictive control (MPC) framework and a stochastic MPC framework in formation of the control policy.

### RELATED APPLICATIONS

This patent application is related to U.S. Provisional Application No. 63/712,828 filed Oct. 28, 2024, entitled “Dual Control for Autonomous Merging with Model-based Diffusion”, in the names of the same inventors which is incorporated herein by reference in its entirety. The present patent application claims the benefit under 35 U.S.C § 119(e) of the aforementioned provisional application.

### BACKGROUND

Interactive decision-making may be needed in applications such as autonomous driving, where the agent may need to infer the behavior of nearby human drivers while planning in real-time. Traditional predict-then-act frameworks may be insufficient or inefficient because accurate inference of human behavior may require a continuous interaction rather than isolated prediction.

Consider a nonlinear stochastic system given as:

$${x}_{t + 1} ∼ f ( {x}_{t} , {u}_{t} , \overline{θ} ) , \qquad ( 1 )$$

where xₜ∈Rⁿ^{ₓ} and uₜ∈Rⁿ^{ᵤ} may denote the state and control action at time-step t∈N, respectively, and θ̅∈Θ⊆Rⁿ^{ₒ} may be a vector of unknown system parameters. Let the cost function associated with (1), for a horizon of length N∈Z⁺ be given as:

$$J ( {x}_{t : t + N} , {u}_{t : t + N - 1} ) = ∅ ( {x}_{t + N} ) + {\sum }_{k = t}^{t + N - 1} {ℓ}_{k} ( {x}_{k} , {u}_{k} ) , \qquad ( 2 )$$

where, for k≥t, u_{t:k}={uₜ, uₜ₊₁, . . . , uₖ}, x_{t:k}={xₜ, xₜ₊₁, . . . , xₖ}, φ(⋅):Rⁿ^{ₓ}→R may be the terminal cost, and [symbol] (⋅, ⋅):Rⁿ^{ₓ}×Rⁿ^{ᵤ}→R may be the stage cost. The goal may be to compute an optimal control policy, uₜ=π*ₜ(xₜ), for (1) by solving the receding horizon problem:

$${min}_{{u}_{t : t + N - 1 \vert t}} E [ ∅ ( {x}_{t + N \vert t} ) + {\sum }_{k = t}^{t + N - 1} {ℓ}_{k} ( {x}_{k \vert t} , {u}_{k \vert t} ) ] \qquad ( 3 a )$$

$$subject to :$$

$${x}_{t \vert t} = {x}_{t} \qquad ( 3 b )$$

$${x}_{k + 1 \vert t} ∼ f ( {x}_{k \vert t} , {u}_{k \vert t} , \overline{θ} ) \qquad ( 3 c )$$

where u_{t:t+N-1|t}={u_{t|t}, u_{t+1|t}, . . . , u_{t+N-1|t}} and u_{k|t} may be the control action for future time k planned at the present time t, and similarly x_{k|t} may be the future state for time k predicted at the present time t.

However, since θ̅ is unknown, Problem (3) may be ill-posed. To resolve this discrepancy, let θ~b(⋅) be an estimate of @ sampled from the belief distribution b(⋅). Using a fixed belief distribution may not take advantage of information obtained during online operation to reduce uncertainty about θ. Therefore, one may estimate θ online using Bayesian inference to refine the belief distribution by conditioning on the history of observations, as in:

$${b}_{t + 1} ( θ ) = b ( θ \vert {ξ}_{0} , … , {ξ}_{t} , {x}_{t + 1} ) \qquad ( 4 )$$

where ξₜ={xₜ, uₜ} may be the observed information. One may introduce the following lemma which may allow for efficiently updating the conditional belief distribution in a recursive manner.

Lemma 1. The posterior belief distribution (4) may be given recursively by:

$${b}_{t + 1} ( θ ) ∝ {b}_{t} ( θ ) f ( {x}_{t + 1} \vert {u}_{t} , θ ) \qquad ( 5 )$$

where b₀(θ)=b(θ) may be the prior distribution.

Proof. Utilizing Bayes rule, one may have:

$${b}_{t + 1} ( θ ) = b ( θ \vert {ξ}_{0} , … , {ξ}_{t} , {x}_{t + 1} ) ∝ b ( {ξ}_{0} , … , {ξ}_{t} , {x}_{t + 1} \vert θ ) b ( θ )$$

Using the Markov property of system (1), one may have:

$${b}_{t + 1} ( θ ) ∝ b ( {ξ}_{0} , … , {ξ}_{t} , {x}_{t + 1} \vert θ ) b ( θ ) ∝ f ( {x}_{1} \vert {x}_{0} , {u}_{0} , θ ) , … , f ( {x}_{t + 1} \vert {x}_{t} , {u}_{t} θ ) b ( θ )$$

which may be concisely given in a recursive form by (5).

Existing methods may typically approximate π*ₜ(xₜ) using a certainty equivalence approach, which may solve:

$${min}_{{u}_{t : t + N - 1 \vert t}} E [ θ ( {x}_{t} + N \vert t ) + {\sum }_{k = t}^{t + N - 1} {ℓ}_{k} ( {x}_{k \vert t} , {u}_{k \vert t} ) ] \qquad ( 6 a )$$

$$subject to :$$

$${x}_{t \vert t} = {x}_{t} \qquad ( 6 b )$$

$${x}_{k + 1 \vert t} ∼ f ( {x}_{k \vert t} , {u}_{k \vert t} , θ ∼ {b}_{t}^{E} [ θ ] ) \qquad ( 6 c )$$

or a stochastic approach, which may solve:

$${min}_{{u}_{t : t + N - 1 \vert t}} E [ ∅ ( {x}_{t} + N \vert t ) + {\sum }_{k = t}^{t + N - 1} {ℓ}_{k} ( {x}_{k \vert t} , {u}_{k \vert t} ) ] \qquad ( 7 a )$$

$$subject to :$$

$${x}_{t \vert t} = {x}_{t} , θ ∼ {b}_{t} ( \cdot ) \qquad ( 7 b )$$

$${x}_{k + 1 \vert t} ∼ f ( {x}_{k \vert t} , {u}_{k \vert t} , θ ) \qquad ( 7 c )$$

However, neither of these methods may account for the estimation process in the design of the control policy. Rather, these methods assume that bₖ(⋅)=bₜ(⋅) for all k=t, . . . , t+N−1. As may be seen from (4), not only is the assumption of a fixed time-invariant belief distribution incorrect, but the future belief distribution may depend on the current control actions. Therefore, there may be a coupling between the control design and parameter estimation which ideally would be accounted for in the optimization. This coupling may result in interactive decision making as now the agent may be enabled to do counterfactual reasoning while planning, as different choice of action results in different belief update and thus different prediction.

### SUMMARY

According to an embodiment of the disclosure, a method of active learning to derive predicted belief distributions for autonomous driving is provided. The method may provide a control policy to reduce an optimality gap between a model predictive control (MPC) framework and a stochastic MPC framework in formation of the control policy.

According to an embodiment of the disclosure, a method of active learning to derive predicted belief distributions for autonomous driving, the method implemented using a computer system including a processor communicatively coupled to a memory device is provided. The method may design a control policy to reduce an optimality gap between a model predictive control (MPC) framework and a stochastic MPC framework by using a Bayesian estimation process in the design of the control policy. The method may use a multi-modal diffusion process for receding horizon optimization.

According to an embodiment of the disclosure, method of active learning to derive predicted belief distributions for autonomous driving is provided. The method may design a control policy to reduce an optimality gap between a model predictive control (MPC) framework and a stochastic MPC framework by using a Bayesian estimation process in the design of the control policy. The method may use a multi-modal diffusion process for receding horizon optimization, wherein the multi-modal diffusion process uses stochastic differential equations (SDE), wherein a prior distribution is generated by corrupting data samples with noise based on the SDE. The method may learn a multimodal dynamic prior distribution to reduce a number of steps for denoising each prior distribution, wherein denoising each prior distribution is done prior to reaching a fixed prior producing Nm unique prior distributions.

### BRIEF DESCRIPTION OF THE DRAWINGS

FIG. 1 show exemplary traffic merge experiments at 8-second increments, with EMPPI (left), active learning with DMPPI (middle) active learning with DMPD (right) in accordance with an embodiment of the disclosure;

FIG. 2 shows an exemplary belief prediction approach for active learning in accordance with an embodiment of the disclosure;

FIG. 3 depicts a block diagram of exemplary recursive generative diffusion in accordance with an embodiment of the disclosure;

FIG. 4 shows a merge scenario using the exemplary belief prediction approach for active learning in accordance with an embodiment of the disclosure;

FIG. 5 shows a platform used for trying the exemplary belief prediction approach for active learning in accordance with an embodiment of the disclosure; and

FIG. 6 show charts of traffic merge experiments with EMPPI, active learning with DMPPI, and the exemplary belief prediction approach for active learning in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The present disclosure relates to an active learning framework in which one may derive predicted belief distributions. Additionally, the present disclosure introduces a model-based diffusion solver tailored for online (receding horizon) optimization, which may be demonstrated through a complex, nonconvex highway merging scenario. The present method may extend previous high fidelity dual control simulations to hardware experiments and may verify behavior inference in human-driven traffic scenarios, moving beyond idealized models like Merge Reaction Intelligent Driver Model (MR-IDM).

One may wish to design an approximate control policy which may reduce the optimality gap between Problems (3) and (7) above by accounting for the Bayesian estimation process in the design of the control policy π*ₜ(xₜ). Such a policy may be referred to as a dual control policy.

### Dual Control

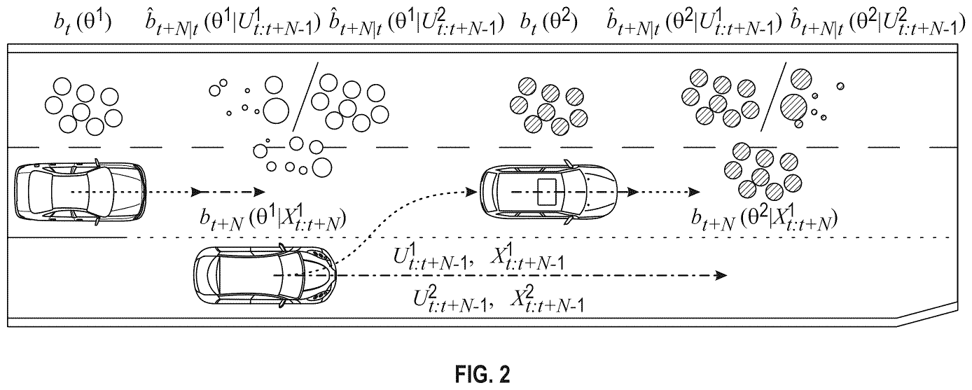

One may simply replace bₜ(⋅) in (7b) with bₖ(⋅) for k=t, . . . , t+N−1. However, as may be seen in (4), bₖ(⋅) may depend on the unknown future realizations of xₖ for k>t. Nonetheless, while the future state realizations may be unknown, one may still harness the information of the planned control actions. Thus, one may predict the future belief distributions by conditioning on the past observations and planned actions, as may be shown in FIG. 2, so that the predicted belief distribution may be given by:

$${\hat{b}}_{k + 1 \vert t} ( θ ) = b ( θ \vert {ξ}_{0} , … , {ξ}_{t} , {u}_{t + 1} , … , {u}_{k} ) \qquad ( 8 )$$

for k−t, . . . , t=N−1

Theorem 1. The predicted belief dynamics (8) may be given by the recursive update:

$${\hat{b}}_{k + 1 \vert t} ( θ ) ∝ {{\hat{b}}_{k \vert t} ( θ )}_{\overline{θ} ∼ {b}_{t}}^{E} [ f ( {x}_{k + 1} \vert {x}_{t} , {u}_{t : k} , θ ) \vert {x}_{t} , {u}_{t : k} , \overline{θ} ] \qquad ( 9 )$$

where \hat{b}ₜₗₜ(θ)=bₜ(θ)

Proof. From Lemma 1, one may have:

$$b ( θ \vert {ξ}_{0} , … , {ξ}_{t} , … , {ξ}_{k} , {x}_{k + 1} ) ∝ {b}_{k} ( θ ) f ( {x}_{k + 1} \vert {x}_{k} , {u}_{k} , θ ) \\ ∝ {b}_{t} ( θ ) f ( {x}_{t + 1} \vert {x}_{t} , {u}_{t} , θ ) … f ( {x}_{x + 1} \vert {x}_{k} , {u}_{k} , θ )$$

where the second line may result from expanding the recursive definition of bₖ. However, since the future states may not be observed, one may expand (8) using the predictive distribution marginalized over the unknown future observations given by:

$$∝ {b}_{t} ( θ ) \int \int {\prod }_{l = t}^{k} f ( {x}_{ℓ + 1} \vert {x}_{ℓ} , {u}_{ℓ} , θ ) {b}_{t} ( θ ) d θ d {x}_{t + 1} \\ ∝ {b}_{t} ( θ ) {\prod }_{l = t}^{k} \int \int f ( {x}_{ℓ + 1} \vert {x}_{ℓ} , {u}_{ℓ} , θ ) {b}_{t} ( θ ) d θ d {x}_{t + 1}$$

which may be concisely expressed in a recursive form by (9).

Corollary 1. The result (9) in Theorem 1, may be interpreted as letting

$${\hat{b}}_{k + 1 \vert t} ( θ ) = E [ {b}_{k + 1} ( θ ) \vert {ξ}_{0} , … , {ξ}_{t} , {u}_{t + 1} , … , {u}_{k} \qquad ( 10 )$$

for k=t, . . . , t=N−1, as an alternative to (8).

Proof. From (10) and applying (4), one may have:

$${\hat{b}}_{k + 1 \vert t} ( θ ) = E [ b ( θ \vert {ξ}_{0} , … , {ξ}_{k} , {x}_{t + 1} ) \vert {ξ}_{0} , … , {ξ}_{t} , {u}_{t + 1} , … , {u}_{k} ]$$

Then, similar to the arguments of Lemma 1,

$${\hat{b}}_{k + 1 \vert t} ( θ ) ∝ 𝔼 [ b ( {ξ}_{0} , … , {ξ}_{k} , {x}_{k + 1} \vert θ ) b ( θ ) \vert {ξ}_{0} , … , {ξ}_{t} , {u}_{t + 1 : k} ] \\ ∝ 𝔼 [ b ( θ ) {\prod }_{ℓ = 0}^{k} f ( {x}_{ℓ + 1} \vert {x}_{ℓ} , {u}_{ℓ} , θ ) \vert {ξ}_{0} , … , {ξ}_{t} , {u}_{t + 1 : k} ] \\ ∝ b ( θ ) {\prod }_{ℓ = 0}^{t - 1} f ( {x}_{ℓ + 1} \vert {x}_{ℓ} , {u}_{ℓ} , θ ) \times 𝔼 [ {\prod }_{ℓ = t}^{k} f ( {x}_{ℓ + 1} \vert {x}_{ℓ} , {u}_{ℓ} , θ ) \vert {ξ}_{0} , … , {ξ}_{t} , {u}_{t + 1 : k} ] \\ ∝ {b}_{t} ( θ ) 𝔼 [ {\prod }_{ℓ = t}^{k} f ( {x}_{ℓ + 1} \vert {x}_{ℓ} , {u}_{ℓ} , θ ) \vert {ξ}_{0} , … , {ξ}_{t} , {u}_{t + 1 : k} ] \\ ∝ {b}_{t} ( θ ) {\prod }_{ℓ = t}^{k} 𝔼 [ f ( {x}_{ℓ + 1} \vert {x}_{ℓ} , {u}_{ℓ} , θ ) \vert {x}_{t} , {u}_{t + 1 : k} ] , \\ \backslash$$

which leads to (9) from Theorem 1, with b_{t|t}(θ)=bₜ(θ).

Using Theorem 1, one may approximate the solution of Problem (3) by solving the optimal control problem:

$${min}_{{u}_{t : t + N - 1 \vert t}} 𝔼 [ ϕ ( {x}_{t + N \vert t} ) + {\sum }_{k = t}^{t + N - 1} {ℓ}_{k} ( {x}_{k \vert t} , {u}_{k \vert t} ) ] , \qquad ( 11 a )$$

$$subject to :$$

$${x}_{t \vert t} = {x}_{t} , θ ∼ {\hat{b}}_{k \vert t} ( \cdot ) , \qquad ( 11 b )$$

$${\hat{b}}_{k + 1 \vert t} ( θ ) = b ( θ \vert {ξ}_{0} , … , {ξ}_{t} , {u}_{t + 1} , … , {u}_{k} ) , \qquad ( 11 c )$$

$${x}_{k + 1 \vert t} ∼ f ( {x}_{k \vert t} , {u}_{k \vert t} , θ ) , \qquad ( 11 d )$$

where we have the following proposition.

Proposition 1. The solution to Problem (11) may be a causal control policy. That is, the optimal control applied at time t may only depend on information available at or before time t.

### Model-Based Diffusion

One may define the cost corresponding to a solution of Problem (11) as:

$${J}_{DC} ( {x}_{t} , {u}_{t : t + N - 1} ) = {{𝔼}_{{θ}_{k} ∼ {\hat{b}}_{k \vert t} ( \cdot ) ,}}_{{x}_{k + 1} ∼ f ( \cdot \vert {x}_{t} , {u}_{t : k} , {θ}_{k} )} [ ϕ ( {x}_{t + N \vert t} ) + {\sum }_{k = t}^{t + N - 1} {ℓ}_{k} ( {x}_{k \vert t} , {u}_{k \vert t} ) ] . \qquad ( 12 )$$

Problem (11) may be a causal stochastic optimal control problem and may be solved by a number of methods. However, in general, the cost function (12) may be non-differentiable owing to penalty functions for collisions, for example. Therefore, one may opt to use a gradient-free sampling-based optimization scheme.

One may define the probability distribution corresponding to (12) as:

$${s}^{0} ( {u}_{t : t + N - 1} \vert {x}_{t} ) ∝ exp ( - \frac{{J}_{DC} ( {x}_{t} , {u}_{t : t + N - 1} )}{λ} ) , \qquad ( 13 )$$

where s⁰(⋅) may approach a Dirac delta function as λ→0. Equation (13) may be interpreted as a probability distribution that may put highest probability on the optimal solution, π*_{DC}(xₜ), of Problem (11). Thus, solving problem (11), may alternatively be interpreted as sampling from (13) with small A.

However, although (13) may allow one to compute the probability density for a given solution, u_{t+N-1}, it may not be practical to directly sample from s⁰(⋅|xₜ). In order to generate approximate samples from (13), one may develop a novel multi-modal variant of the model-based diffusion algorithm presented below, tailored for the specific application of solving receding horizon problems.

Generative Diffusion Models: Diffusion may address the problem in generative modeling of how to draw novel samples from a distribution, \tilde{y}⁰~q⁰(⋅). In the case of data-driven model-free diffusion, the distribution q⁰(⋅) may be unknown, but empirical samples from the unknown distribution,

$${\{ {y}_{j}^{0} \}}_{j = 1}^{N s} ∼ {q}^{{}_{0}} ( y ) ,$$

may be given. In the case of analytical model-based diffusion, the probability density function of q⁰(⋅) may be available. In either case, rather than sampling from q⁰(⋅) directly, diffusion may draw samples from a prior distribution q^{Nd} and then may map them back to the desired distribution.

Several formulations of diffusion models may exist, but the most general may be that of stochastic differential equations (SDE). In this case, the prior distribution may be generated by corrupting the data samples with noise according to a handcrafted SDE. Let the transition dynamics from q⁰(⋅) to q^{Nd} (⋅) be given by:

$${y}^{i + 1} = ( I + {\tilde{A}}^{{}_{i}} ) {y}^{i} + {B}^{i} {z}^{i} , \qquad ( 14 )$$

for i=0, 1, . . . , N_{d}−1, where zⁱ~N(0, I) and y⁰~q⁰(⋅).

Lemma 2. The conditional distribution, q^{i|0}(yⁱ|y⁰), resulting from the forward dynamics (14), may be given by:

$${q}^{i \vert 0} ( {y}^{i} \vert {y}^{0} ) = 𝒩 ( {μ}^{i} ( {y}^{0} ) , {\sum }^{i} ) , \qquad ( 15 )$$

$$where :$$

$${μ}^{i + 1} ( {y}^{0} ) = {\prod }_{j = 0}^{i} ( I + {\tilde{A}}^{j} ) {y}^{0} , \qquad ( 16 a )$$

which may be equivalent to the dynamical system:

$${μ}^{i + 1} = ( I + {\tilde{A}}^{j} ) {μ}^{\text{?}} , \qquad ( 16 b )$$

$$\text{?} \text{indicates text missing or illegible when filed}$$

where μ⁰=y⁰, and where:

$${\sum }^{i + 1} = ( I + {\tilde{A}}^{\text{?}} ) {\sum }^{i} {( I + {\tilde{A}}^{\text{?}} )}^{T} + {B}^{i} {B}^{{i}^{T}} , \qquad ( 16 c )$$

$$\text{?} \text{indicates text missing or illegible when filed}$$

where Σ0=0.

The result may be determined by computing the conditional distributions using the linear dynamics (14).

Remark 1. In practice, the forward process may be constructed such that q^{Nd}(⋅)=q(y^{Nd}|y⁰)→N(0, I) as N_{d}→∞, for all y⁰~q⁰(⋅). The approximation q^{Nd} (⋅)=N(0, I) then may allow for sampling from a fixed prior distribution at inference time.

Samples from the prior distribution may be “denoised” back to the data distribution by reversing the SDE.

Proposition 2. The forward diffusion process given by (14) may be reversed by the discrete SDE given by:

$${y}^{i - 1} = ( I - {{A}^{\text{?}}}^{i} ) {y}^{\text{?}} + {B}^{i} {B}^{{i}^{T}} {∇}_{y} log {q}^{\text{?}} ( {y}^{i} ) + {B}^{i} {z}^{i} , \qquad ( 17 )$$

$$\text{?} \text{indicates text missing or illegible when filed}$$

or alternatively by the ODE:

$${y}^{i - 1} = ( I - {\tilde{A}}^{i} ) {y}^{i} + \frac{1}{2} {B}^{\text{?}} {B}^{{i}^{T}} {∇}_{y} log {q}^{i} ( {y}^{\text{?}} ) . \qquad ( 18 )$$

$$\text{?} \text{indicates text missing or illegible when filed}$$

In general, the desired data distribution may be unknown, in which case ∇_{y} log q(yⁱ) may be learned from data. However, in the case where the desired distribution may be known (even if it cannot be sampled from), it may be possible to compute ∇_{y} log q(yⁱ) directly, bypassing the training process.

Proposition 3. The score function ∇_{y} log q(yⁱ) may be computed explicitly using q⁰(y⁰):

$${∇}_{\text{?}} log {q}^{i} ( {y}^{i} ) = - {\sum }^{{i}^{- 1}} {y}^{i} + {\sum }^{{i}^{- 1}} \frac{\int {μ}^{i} ( {y}^{0} ) 𝒩 ( {y}^{i} \vert {μ}^{i} ( {y}^{0} ) , {\sum }^{i} ) q ( {y}^{0} ) {dy}^{0}}{\int 𝒩 ( {y}^{i} \vert {μ}^{\text{?}} ) , {\sum }^{\text{?}} ) q ( {y}^{0} ) {dy}^{0}} . \qquad ( 19 )$$

$$\text{?} \text{indicates text missing or illegible when filed}$$

which may be approximated using importance sampling as:

$${∇}_{y} log {q}^{i} ( {y}^{i} ) \approx - {\sum }^{{i}^{- 1}} {y}^{i} + {\sum }^{{i}^{- 1}} \frac{{\sum }_{j = 1}^{{N}_{\text{?}}} {μ}^{i} ( {y}^{0 , j} ) q ( {y}^{0 , j} )}{{\sum }_{j = 1}^{{N}_{\text{?}}} q ( {y}^{0 , j} )} , \qquad ( 20 )$$

$$\text{?} \text{indicates text missing or illegible when filed}$$

where y^{0,j}~N(Āⁱ⁻¹ yⁱ, Ā^{iT} Σⁱ⁻¹ Ā⁻) and Ā^{j}=Πⱼ₌₀ⁱ (I+Ã^{j}), for all j=1, . . . , Nₛ and i=N_{d}, . . . , 1.

Proof. The result may be derived as follows:

$${∇}_{\text{?}} log {q}^{\text{?}} ( {y}^{\text{?}} ) = \frac{{∇}_{\text{?}} {q}^{\text{?}} ( {y}^{\text{?}} )}{{q}^{\text{?}} ( {y}^{\text{?}} )} = \frac{{∇}_{\text{?}} \int q ( {y}^{\text{?}} \vert {y}^{0} ) q ( {y}^{0} ) {dy}^{0}}{\int q ( {y}^{\text{?}} \vert {y}^{0} ) q ( {y}^{0} ) {dy}^{0}} = \frac{\int {∇}_{\text{?}} q ( {y}^{\text{?}} \vert {y}^{0} ) q ( {y}^{0} ) {dy}^{0}}{\int q ( {y}^{\text{?}} \vert {y}^{0} ) q ( {y}^{0} ) {dy}^{0}} = \frac{\int {∇}_{\text{?}} 𝒩 ( {y}^{\text{?}} \vert {μ}^{\text{?}} ( {y}^{0} ) , {\sum }^{\text{?}} ) q ( {y}^{0} ) {dy}^{0}}{\int 𝒩 ( {y}^{\text{?}} \vert {μ}^{\text{?}} ( {y}^{0} ) , {\sum }^{\text{?}} ) q ( {y}^{0} ) {dy}^{0}} = \frac{\int - {\sum }^{{i}^{- 1}} ( {y}^{\text{?}} - {μ}^{\text{?}} ( {y}^{0} ) ) 𝒩 ( {y}^{\text{?}} \vert {μ}^{\text{?}} ( {y}^{0} ) , {\sum }^{\text{?}} ) q ( {y}^{0} ) {dy}^{0}}{\int 𝒩 ( {y}^{\text{?}} \vert {μ}^{\text{?}} ( {y}^{0} ) , {\sum }^{\text{?}} ) q ( {y}^{0} ) {dy}^{0}} = - {\sum }^{{i}^{- 1}} {y}^{i} \frac{\int 𝒩 ( {y}^{\text{?}} \vert {μ}^{\text{?}} ( {y}^{0} ) , {\sum }^{\text{?}} ) q ( {y}^{0} ) {dy}^{0}}{\int 𝒩 ( {y}^{\text{?}} \vert {μ}^{\text{?}} ( {y}^{0} ) , {\sum }^{\text{?}} ) q ( {y}^{0} ) {dy}^{0}} + \frac{\int {\sum }^{{i}^{- 1}} {μ}^{\text{?}} ( {y}^{0} ) 𝒩 ( {y}^{\text{?}} \vert {μ}^{\text{?}} ( {y}^{0} ) , {\sum }^{\text{?}} ) q ( {y}^{0} ) {dy}^{0}}{\int 𝒩 ( {y}^{\text{?}} \vert {μ}^{\text{?}} ( {y}^{0} ) , {\sum }^{\text{?}} ) q ( {y}^{0} ) {dy}^{0}} = - {\sum }^{{i}^{- 1}} {y}^{i} + \frac{\int {\sum }^{{i}^{- 1}} {μ}^{\text{?}} ( {y}^{0} ) 𝒩 ( {y}^{\text{?}} \vert {μ}^{i} ( {y}^{0} ) , {\sum }^{\text{?}} ) q ( {y}^{0} ) {dy}^{0}}{\int 𝒩 ( {y}^{\text{?}} \vert {μ}^{\text{?}} ( {y}^{0} ) , {\sum }^{\text{?}} ) q ( {y}^{0} ) {dy}^{0}}$$

$$\text{?} \text{indicates text missing or illegible when filed}$$

where in the first line one may apply the chain rule of derivation, in the second, one may use Baye's theorem to express qⁱ(yⁱ), in the third, one may move the derivative inside the integral since the gradient may be taken with respect to yⁱ whereas the variable of integration may be y⁰, in the fourth, one may apply Lemma 2, in the fifth, one may take the gradient of the Gaussian distribution

$$N ( {y}^{i} \vert {μ}^{i} ( {y}^{0} ) , {\sum }^{i} ) ∝ exp ( - \frac{1}{2} {( {y}^{i} - {μ}^{i} ( {y}^{0} ) )}^{T} {\sum }^{i - 1} ( {y}^{i} - {μ}^{\text{?}} ( {y}^{0} ) ) ) ,$$

$$\text{?} \text{indicates text missing or illegible when filed}$$

in the sixth, one may expand and pull coefficients outside the integral, and then one may simplify to obtain the result. The importance sampling approximation may be obtained by reparameterizing:

$$𝒩 ( {y}^{\text{?}} \vert {μ}^{\text{?}} ( {y}^{0} ) , {\sum }^{\text{?}} ) ∝ exp ( - \frac{1}{2} {( {y}^{\text{?}} - {μ}^{i} ( {y}^{0} ) )}^{T} {\sum }^{{i}^{- 1}} ( {y}^{\text{?}} - {μ}^{\text{?}} ( {y}^{0} ) ) ) = exp ( - \frac{1}{2} {( {\overline{A}}^{{i}^{- 1}} {y}^{\text{?}} {y}^{0} )}^{T} {\overline{A}}^{{i}^{T}} {\sum }^{{i}^{- 1}} {\overline{A}}^{i} ( {\overline{A}}^{{i}^{- 1}} {y}^{\text{?}} - {y}^{0} ) )$$

$$\text{?} \text{indicates text missing or illegible when filed}$$

so as to sample y⁰, rather than yⁱ, since y⁰ may be the variable of integration.

Model Predictive Diffusion: Although the model-based diffusion algorithm may be able to solve optimization problems by generating samples from the optimal distribution, it may have several limitations which may hinder its application to model predictive control. First, the iterative denoising process may be computationally intensive as many denoising steps may need to be performed sequentially in order to move the samples towards the optimal value, and reducing the number of steps may lead to sub-optimal solutions. Second, model-based diffusion assumes a fixed, unimodal Gaussian prior which may not allow for leveraging prior knowledge about the specific problem being solved. Third, model-based diffusion does not exploit the online solution structure of model predictive control, and, rather, every time the problem should be solved, all previous information about the previous optimal solution may be discarded.

One may address these deficiencies by proposing a novel variant of model-based diffusion, tailored to the special structure of model predictive control. The proposed architecture may reduce the number of steps required for the compute-intensive iterative denoising process by learning a multimodal dynamic prior distribution so that samples may be drawn closer to the optimal distribution.

Consider Nₘ samples drawn from the optimal distribution s⁰(⋅|xₜ), given by

$${\{ {u}_{t : t + N - 1}^{0 , j} \}}_{j = 1}^{Nm} .$$

These may be converted to noise following the forward diffusion process given by:

$${u}_{t : t + n - 1}^{i + 1 , j} = ( I + {{A}^{\text{?}}}^{i} ) {u}_{t : t + N - 1}^{i , j} + {B}^{i} {z}^{i , j} , \qquad ( 21 )$$

$$\text{?} \text{indicates text missing or illegible when filed}$$

for i=0, . . . , N_{d}−1, where z^{i,j}~N(0, I), resulting in:

$${u}_{t : t + N - 1}^{i + 1 , j} ∼ {s}^{i + 1} ( \cdot \vert {u}_{t : t + N - 1}^{0 , j} , {x}_{t} ) = 𝒩 ( \cdot \vert {{A}^{\text{?}}}^{i} {u}_{t : t + N - 1}^{0 , j} , {\sum }^{i} ) , \qquad ( 22 )$$

$$\text{?} \text{indicates text missing or illegible when filed}$$

for j=1, . . . , Nₘ, where

$${\overline{A}}^{i} = {Π}_{j = 0}^{i} ( I + {\overline{A}}^{j} ) .$$

Samples from the priors may then be denoised to generate samples from the optimal distribution s⁰(⋅|xₜ) using the following result.

Theorem 2. The diffusion process given by (21), or, equivalently, (22), may be reversed by the discrete SDE:

$${u}_{t : t + N - 1}^{i - 1 , j} = ( I - {{A}^{\text{?}}}^{i} ) {u}_{t : t + N - 1}^{i , j} + \frac{1}{2} {B}^{i} {B}^{{i}^{T}} {∇}_{{u}_{t : t + N - 1}^{\text{?}}} log {\text{?}}^{i} ( {u}_{t : t + N - 1}^{\text{?}} ) + {B}^{i} {z}^{i , j} , \qquad ( 23 )$$

$$\text{?} \text{indicates text missing or illegible when filed}$$

or by the discrete ODE:

$${u}_{t : t + N - 1}^{i - 1 , j} = ( I - {{A}^{\text{?}}}^{i} ) {u}_{t : t + N - 1}^{i , j} + \frac{1}{2} {B}^{i} {B}^{{i}^{T}} {∇}_{{u}_{t : t + N - 1}^{\text{?}}} log {\text{?}}^{i} ( {u}_{t : t + N - 1}^{\text{?}} ) . \qquad ( 24 )$$

$$\text{?} \text{indicates text missing or illegible when filed}$$

Proof. The equivalence of (21) and (22) may easily be seen from Lemma 2. The results (23) and (24) follow immediately from Proposition 2.

This may give rise to the proposed generative diffusion model. Rather than allowing the diffusion process to proceed for enough steps to reach a fixed prior which may be unconditional of the samples from the optimal distribution, as is usually the case, one may instead limit the number of steps to reduce computation, producing Nₘ unique prior distributions. For each of these modes, the denoising process in Theorem 2 may be evaluated using the following result.

Theorem 3. The score function

$${∇}_{{u}_{t : t + n - 1}}^{i , j} log {s}^{i} ( {u}_{t : t + N - 1}^{i , j} )$$

may be computed explicitly using s⁰(⋅|xₜ), may be computed

$${∇}_{{u}_{t : t + n - 1}}^{i , j} log {s}^{i} ( {u}_{t : t + N - 1}^{i , j} ) = - {\sum }^{{i}^{- 1}} {u}_{t : t + N - 1}^{i , j} + {\sum }^{{i}^{- 1}} \frac{\int {\overline{A}}^{i} {u}_{t : t + N - 1}^{0 , j} 𝒩 ( \cdot \vert {\overline{A}}^{i} {u}_{t : t + N - 1}^{0 , j} , {\sum }^{i} ) {s}^{0} ( \cdot ) {du}_{t : t + N - 1}^{0 , j}}{\int 𝒩 ( \cdot \vert {\overline{A}}^{i} {u}_{t : t + N - 1}^{0 , j} , {\sum }^{i} ) {s}^{0} ( {u}_{t : t + N - 1}^{0 , j} ) {du}_{t : t + N - 1}^{0 , j}} , \qquad ( 25 )$$

which may be approximated using importance sampling as:

$${∇}_{{u}_{t : t + n - 1}}^{i , j} log {s}^{i} ( {u}_{t : t + N - 1}^{i , j} ) \approx - {\sum }^{{i}^{- 1}} {u}_{t : t + N - 1}^{i , j} + {\sum }^{{i}^{- 1}} \frac{{\sum }_{ℓ = 1}^{{N}_{s}} {\overline{A}}^{i} {u}_{t : t + N - 1}^{0 , j , ℓ} 𝒩 ( \cdot \vert {\overline{A}}^{i} {u}_{t : t + N - 1}^{0 , j} {s}^{0} ( {u}_{t : t + N - 1}^{0 , j , ℓ} )}{{\sum }_{ℓ = 1}^{{N}_{s}} {s}^{0} ( {u}_{t : t + N - 1}^{0 , j , ℓ} )} , \qquad ( 26 )$$

$$where$$

$${u}_{t : t + N - 1}^{0 , j , ℓ} \sim 𝒩 ( {\overline{A}}^{{i}^{- 1}} {u}_{t : t + N - 1}^{i , j} , {\overline{A}}^{{i}^{T}} {\sum }^{i} {\overline{A}}^{i} ) \qquad ( 27 )$$

and where

$${\overline{A}}^{i} = {\prod }_{j = 0}^{i} ( l + {\overline{A}}^{j} ) ,$$

for all [symbol] =1, . . . , Nₛ and i=N_{d}, . . . , 1.

Proof. The result may follow immediately from Proposition 3

The key issue may be how to generate the samples

$${\{ {u}_{t : t + N - 1}^{i , j} \sim {s}^{0} ( \cdot \vert {x}^{t} ) \}}_{j = 1}^{Nm}$$

from the optimal distribution. One may exploit the receding horizon structure of MPC by utilizing the common assumption that the optimal solution may be similar between consecutive time-steps, and employ the approximation s⁰(⋅|xₜ₊₁)≈s⁰(⋅|xₜ). Thus, the previous solutions may be used to bootstrap the diffusion process at the next sampling time using:

$${u}_{t + 1 : t + N}^{{N}_{d} , j} \sim 𝒩 ( {\overline{A}}^{{N}_{d} - 1} {u}_{t : t + N - 1}^{0 , j} , {\sum }^{{N}_{d} - 1} ) . \qquad ( 28 )$$

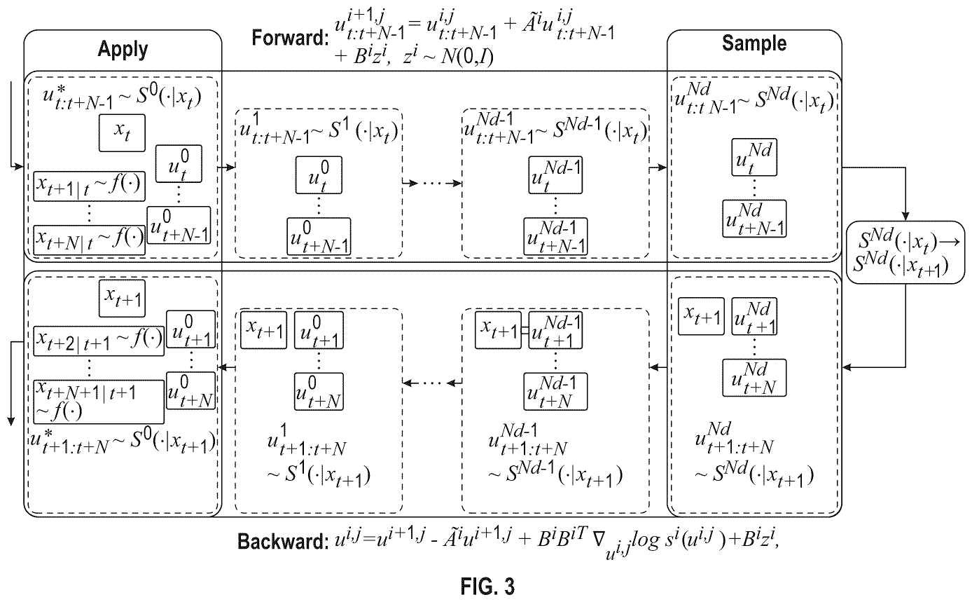

This process may be summarized by Algorithm 1 and in FIG. 3.

Algorithm 1 Model Predictive Generative Diffusion

```
Require: Number of modes, number of diffusion steps: Nₘ, N_{d}
Require: Optimal probability distribution function s⁰ (·)
$Require : Initial control samples guess : {\{ {u}_{- 1 : N - 2}^{0 , j} \}}_{j = 1}^{{N}_{m}}$
$Require : Forward diffusion dynamics parameters : {\{ {A}^{i} , {B}^{i} \}}_{i = 1}^{{N}_{d}}$
  1: for t = 0, 1, . . . do
  2: for j = 1, ... . Nₘ do
  3: Sample from prior distribution using (28)
  4: for i = N_{d} - 1, . . . , 0 do
  $5 : Calculate {∇}_{{u}_{t : t + N - 1}^{i , j}} log {s}^{i} ( \cdot ) using Theorem 3$
  6: Take one step of the backwards dynamics using Theorem 2
  7: end for
  8: end for
  $9 : Select optimal {u}_{t : t + N - 1}^{*} from {\{ {u}_{t : t + N - 1}^{0 , j} \}}_{j = 1}^{{N}_{m}}$
10: end for
```

Remark 2. Observe that when N_{d}=1, Nₘ=1, and Āⁱ=I, (24) may reduce to:

$${u}_{t : t + N - 1}^{0 , 1} = \frac{{\sum }_{ℓ = 1}^{{N}_{s}} {u}_{t : t + N - 1}^{0 , 1 , ℓ} {s}^{0} ( {u}_{t : t + N - 1}^{0 , 1 , ℓ} )}{{\sum }_{ℓ = 1}^{{N}_{s}} {s}^{0} ( {u}_{t : t + N - 1}^{0 , 1 , ℓ} )} , \qquad ( 29 )$$

where

$${u}_{t : t + N - 1}^{0 , 1 , ℓ} \sim N ( {u}_{t : t + N - 1}^{Nd , 1} , \frac{1}{2} {B}^{Nd} {B}^{NdT} ) .$$

Equation (29) may be the important sampling policy employed by model predictive path integral control.

Proof. Utilizing (24) and (26), we have:

$$\begin{matrix}{u}_{t : t + N - 1}^{0 , 1} = ( I - {\overline{A}}^{{N}_{d}} ) {u}_{t : t + N - 1}^{{N}_{d} , 1} \\ + \frac{1}{2} {B}^{{N}_{d}} {B}^{{{N}_{d}}^{T}} {∇}_{{u}_{t : t + N - 1}^{{N}_{d} , 1}} log {s}^{{N}_{d}} ( {u}_{t : t + N - 1}^{{N}_{d} , 1} )\end{matrix}$$

$$\begin{matrix}{u}_{t : t + N - 1}^{0 , 1} = ( I - {\overline{A}}^{{N}_{d}} ) {u}_{t : t + N - 1}^{{N}_{d} , 1} \\ + \frac{1}{2} {B}^{{N}_{d}} {B}^{{{N}_{d}}^{T}} [ - {\sum }^{{N}_{d}^{- 1}} {u}_{t : t + N - 1}^{{N}_{d} , 1} \\ + {\sum }^{{N}_{d}^{- 1}} \frac{{\sum }_{ℓ = 1}^{{N}_{0}} {\overline{A}}^{{N}_{d}} {u}_{t : t + N - 1}^{0 , j , ℓ} {s}^{0} ( {u}_{t : t + N - 1}^{0 , 1 , ℓ} )}{{\sum }_{ℓ = 1}^{{N}_{s}} {s}^{0} ( {u}_{t : t + N - 1}^{0 , 1 , ℓ} )} ]\end{matrix}$$

$$\begin{matrix}{u}_{t : t + N - 1}^{0 , 1} = {u}_{t : t + N - 1}^{{N}_{d} , 1} \\ + \frac{1}{2} {B}^{{N}_{d}} {B}^{{{N}_{d}}^{T}} [ - {( {B}^{{N}_{d}} {B}^{{N}_{d}^{T}} )}^{- 1} {u}_{t : t + N - 1}^{{N}_{d} , 1} \\ + {( {B}^{{N}_{d}} {B}^{{{N}_{d}}^{T}} )}^{- 1} \frac{{\sum }_{ℓ = 1}^{{N}_{s}} {u}_{t : t + N - 1}^{0 , 1 , ℓ} {s}^{0} ( {u}_{t : t + N - 1}^{0 , 1 , ℓ} )}{{\sum }_{ℓ = 1}^{{N}_{s}} {s}^{0} ( {u}_{t : t + N - 1}^{0 , 1 , ℓ} )} ] ,\end{matrix}$$

$$\begin{matrix}{u}_{t : t + N - 1}^{0 , 1} = {u}_{t : t + N - 1}^{{N}_{d} , 1} - \frac{1}{2} {u}_{t : t + N - 1}^{{N}_{d} , 1} \\ + \frac{1}{2} \frac{{\sum }_{ℓ = 1}^{{N}_{s}} {u}_{t : t + N - 1}^{0 , 1 , ℓ} {s}^{0} ( {u}_{t : t + N - 1}^{0 , 1 , ℓ} )}{{\sum }_{ℓ = 1}^{{N}_{s}} {s}^{0} ( {u}_{t : t + N - 1}^{0 , 1 , ℓ} )} ,\end{matrix}$$

$$where {u}_{t : t + N - 1}^{0 , 1 , ℓ} \sim N ( {u}_{t : t + N - 1}^{Nd , 1} , \frac{1}{2} {B}^{Nd} {B}^{NdT} ) .$$

$$Thus :$$

$$\begin{matrix}{u}_{t : t + N - 1}^{0 , 1} = {u}_{t : t + N - 1}^{{N}_{d} , 1} - \frac{1}{2} {u}_{t : t + N - 1}^{{N}_{d} , 1} + \frac{1}{2} {u}_{t : t + N - 1}^{{N}_{d} , 1} \\ + \frac{1}{2} \frac{{\sum }_{ℓ = 1}^{{N}_{s}} {\tilde{u}}_{t : t + N - 1}^{0 , 1 , ℓ} {s}^{0} ( {\tilde{u}}_{t : t + N - 1}^{0 , 1 , ℓ} )}{{\sum }_{ℓ = 1}^{{N}_{s}} {s}^{0} ( {\tilde{u}}_{t : t + N - 1}^{0 , 1 , ℓ} )} ,\end{matrix}$$

$${u}_{t : t + N - 1}^{0 , 1} = {u}_{t : t + N - 1}^{{N}_{d} , 1} + \frac{1}{2} \frac{{\sum }_{ℓ = 1}^{{N}_{s}} {\tilde{u}}_{t : t + N - 1}^{0 , 1 , ℓ} {s}^{0} ( {\tilde{u}}_{t : t + N - 1}^{0 , 1 , ℓ} )}{{\sum }_{ℓ = 1}^{{N}_{s}} {s}^{0} ( {\tilde{u}}_{t : t + N - 1}^{0 , 1 , ℓ} )} ,$$

where

$${\tilde{u}}_{t : t + N - 1}^{0 , 1 , ℓ} \sim N ( 0 , {B}^{Nd} {B}^{NdT} ) ,$$

which may reduce to the result (29).

Thus, the dual MPPI algorithm employed in the prior work may be interpreted as a special case of the proposed approach.

### Sampling Approximation

One may utilize sampling-based approximations to update the belief distribution (5), conditional predicted belief distributions (9), and expected cost (11). Additionally, one may utilize the importance sampling approximation suggested by Theorem 3 to evaluate the gradient steps of the denoising process.

The belief distribution may be learned online using a particle filter. Draw Nₚ samples from b(⋅) according to:

$${θ}^{j} \sim b ( \cdot ) , j = 1 , … , {N}_{p} , \qquad ( 30 )$$

and initialize the corresponding weights to

$${ω}_{0}^{j} = 1 / {N}_{p} .$$

The belief distribution may then be approximated online by updating the weights according to:

$${ω}_{i + t}^{j} ∝ {ω}_{t}^{j} f ( {x}_{t + 1} \vert {x}_{t} , {u}_{t} , {θ}^{j} ) , \qquad ( 31 )$$

which may be the particle approximation of (5).

Remark 3. Various resampling schemes may be added to (30)-(31) to enrich the sampled parameters. However, this may be an implementation consideration rather than a theoretical one, and as noted above, one may find it unnecessary for the application to be considered.

The predicted belief distribution may be propagated using a similar particle approximation. The predicted particles may be resampled using the current belief distribution:

$${\hat{θ}}_{t}^{j} \sim {b}_{t} ( \cdot ) , j = 1 , … , {\hat{N}}_{p} , \qquad ( 32 )$$

and the predicted weights may be initialized as

$${\hat{ω}}_{t \vert t}^{j} = {\hat{N}}_{p} .$$

The weights may then be forward predicted using a particle approximation of (9), given by:

$${\hat{ω}}_{k + 1 \vert t}^{j} ∞ {\hat{ω}}_{k \vert t}^{j} f ( {𝔼}_{\overline{θ} ∼ {b}_{t}} [ {x}_{k + 1} \vert {x}_{t} , {u}_{t : k} , \overline{θ} ] \vert {x}_{t} , {u}_{t : k} , {\hat{θ}}_{t}^{j} ) , \qquad ( 33 )$$

for k=t, t+1, . . . , t+N−1, where one may move the expectation inside the pdf to reduce the number of costly evaluations of the pdf.

Finally, the cost of Problem (11) may be evaluated using the sample average approximation given by:

$${min}_{{u}_{t : t + N - 1 \vert t}} {\sum }_{j = 1}^{{N}_{p}} [ ϕ ( {x}_{t + N \vert t}^{j} ) {\hat{ω}}_{t + N \vert t}^{j} + {\sum }_{k = i}^{t + N - 1} {ℓ}_{k} ( {x}_{k \vert t}^{j} , {u}_{k \vert t} ) {\hat{ω}}_{k \vert t}^{j} ] , \qquad ( 34 a )$$

$$subject to :$$

$${x}_{t \vert t}^{j} = {x}_{t} , {\hat{θ}}_{t}^{j} ∼ {b}_{t} ( \cdot ) , {\hat{ω}}_{t \vert t}^{j} = 1 / {\hat{N}}_{p} j = 1 , … , {\hat{N}}_{p} , \qquad ( 34 b )$$

$${\hat{ω}}_{k + 1 \vert t}^{j} ∞ {\hat{ω}}_{k \vert t}^{j} f ( \frac{1}{{\hat{N}}_{p}} {\sum }_{j = 1}^{{\hat{N}}_{p}} {x}_{k + 1 \vert t}^{j} \vert {x}_{t} , {u}_{t : k \vert t} , {\hat{θ}}_{t}^{j} ) , \qquad ( 34 c )$$

$${x}_{k + 1 \vert t}^{j} ∼ f ( {x}_{k \vert t}^{j} , {u}_{k \vert t} , {\hat{θ}}^{j} ) . \qquad ( 34 d )$$

Associated with problem (34), one may have the following theorem.

Theorem 4. The solution to problem (34) may preserve the dual control effect, that is, the planned control actions may affect the entropy of the predicted future belief distribution.

Proof. The proof follows from (33), in which the planned control sequence u_{t.k|t} may affect the weights

$${\hat{ω}}_{k + 1 \vert t}^{j}$$

of the categorical distribution over

$${\{ {θ}^{j} \}}_{j = 1}^{Np} .$$

Finally, the proposed dual model predictive diffusion approach may be summarized in Algorithm 2.

Algorithm 2 Dual Model Predictive Diffusion

```
Require: Number of particles, downsampled particle count, number of
      modes, number of diffusion steps, importance sampling size: Nₚ, \hat{N}ₚ,
      Nₘ, N_{d}, Nₛ
Require: Prior parameter belief distribution b (θ), dynamics f (·, ·, ·), cost
      function J_{DC} (·, ·)
$Require : Prior control samples / guess : {\{ {u}_{- 1}^{0 , j} \}}_{j = 1}^{{N}_{m}}$
$Require : Forward diffusion dynamics parameters : {\{ {\tilde{A}}^{i} , {B}^{i} \}}_{i = 1}^{{N}_{d}}$
  1: Initialize belief distribution b₀ (·) = b (·), sample parameters using (30),
        $and initialize weights {ω}_{0}^{j} = 1 / {N}_{p}$
  2: for t = 0, 1, . . . do
  3: Update belief weights using (31)
  4: Sample predicted parameters using (32) and initialize predicted
        $weights {\hat{ω}}_{t \vert t}^{j} = 1 / {\hat{N}}_{p}$
  5: Sample Nₘ control sequences from the prior (28)
  6: for i = N_{d} - 1, . . . , 0 do
  7: Sample Nₘ × Nₛ control sequences from (27)
  8: Propagate the dynamics using (34d)
  9: Propagate the weights according to (34c)
10:  Compute the cost according to (34a)
11: Evaluate the optimal pdf according to (13)
12: Estimate the score function using (26)
13: Take one step of the backwards dynamics using (24)
14: end for
$15 : Select and apply optimal {u}_{t : t + N - 1}^{*} from {\{ {u}_{t : t + N - 1}^{0 , j} \}}_{j = 1}^{{N}_{m}}$
16: end for
```

### Interactive Autonomous Driving

The proposed method may be evaluated in a challenging interactive autonomous driving application where an autonomous ego vehicle should successfully complete a lane change/merge with one of several non-cooperative traffic vehicles. In particular, one may consider congested driving conditions in which inter-vehicle interaction may be necessary to successfully complete the merge before reaching the end of the merge window. Moreover, one may consider traffic vehicles having unknown heterogeneous driving behaviors, with varying levels of friendliness vs. aggressive behavior, so that the ego vehicle may need to successfully identify the other vehicles' behaviors online in order to complete the merge.

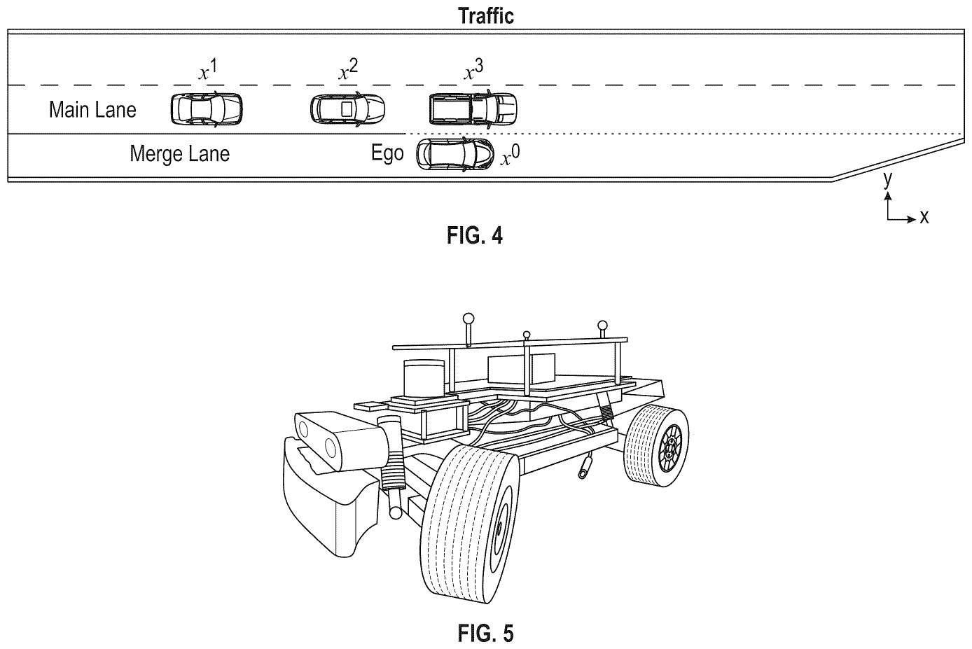

One may consider a scenario shown in FIG. 4 with one ego vehicle in the merge lane and nᵥ traffic vehicles in the main lane. The state of the vehicles at time t may be given by

$${x}_{t}^{i} = {[ {v}_{t}^{i} ; {Ψ}_{t}^{i} ; {X}_{t}^{i} ; {Y}_{t}^{i} ]}^{⊤}$$

where i=0, 1, . . . , nᵥ, where 0 may be the index of the ego vehicle, 1 may be the index of the rear-most traffic vehicle, nᵥ may be the index of the lead traffic vehicle, and where v may be the vehicle's longitudinal velocity, Ψ may be the heading angle, and X and Y may be the Cartesian position. The state of all vehicles may be given by the stacked vector

$${x}_{t} = {[ {x}_{t}^{0 Ti} , {Ψ}_{t}^{i 1 T} , … , {x}_{t}^{nvT} ]}^{⊤} ,$$

and it may be assumed that the state xₜ may be fully observable to all vehicles.

In contrast to previous work, in which one may have used Dual MPPI only for generating a motion plan which may have then been followed by a low-level controller, in the present method, one may utilize the proposed approach as an integrated motion planner and control algorithm. Consequently, one may consider the decision variables of the ego vehicle to be the steering angle

$${δ}_{t}^{0}$$

and the longitudinal acceleration

$${u}_{t} = {[ {a}_{t}^{0} , {δ}_{t}^{0} ]}^{⊤} .$$

so that the control action may be given by

$${a}_{t}^{0} ,$$

The vehicle dynamics may be modeled using the kinematic bicycle model, given by:

$${\dot{v}}_{t}^{i} = {a}_{t}^{i} , \qquad ( 35 a )$$

$${\dot{Ψ}}_{t}^{i} = sin ( {β}_{t}^{i} ) {v}_{t}^{i} / {L}_{r}^{i} , \qquad ( 35 b )$$

$${\dot{X}}_{t}^{i} = {v}_{t}^{i} cos ( {ψ}_{t}^{i} + {β}_{t}^{i} ) , \qquad ( 35 c )$$

$${\dot{Y}}_{t}^{i} = {v}_{t}^{i} sin ( {ψ}_{t}^{i} + {β}_{t}^{i} ) , \qquad ( 35 d )$$

Where

$${β}_{t}^{i} = arctan ( \frac{{L}_{r}^{i}}{{L}_{f}^{i} + {L}_{r}^{i}} tan ( {δ}_{t}^{i} ) ) ,$$

and where L_{f} and Lᵣ may be the distances between the center of mass and the front and rear axles, respectively, which may be assumed known for all vehicles. As in previous works, one may model the acceleration of the traffic vehicles using the merge-reactive intelligent driver model (MR-IDM),

$${a}_{t}^{i} = p ( {x}_{t} , {e}^{i} ) ,$$

for i=1, . . . , nᵥ, where eⁱ are the i^{th} vehicle's driving behavior parameters. Therefore, the dynamics model may be given by:

$$f ( {x}_{t} , {u}_{t} , θ ) = {x}_{t} + [ {{\dot{x}}_{t}^{0} ( {x}_{t}^{0} , σ ( {u}_{t} ) )}^{⊤} , {{\dot{x}}_{t}^{1} ( {x}_{t}^{1} , ρ ( {x}_{t} , {θ}^{1} ) )}^{⊤} , … , \qquad ( 36 )$$

$${{{\dot{x}}_{t}^{{n}_{v}} ( {x}_{t}^{{n}_{v}} , ρ ( {x}_{t} , {θ}^{{n}_{v}} ) )}^{⊤} ]}^{⊤} Δ t + {w}_{t} ,$$

where Θ=[Θ^{1T}, . . . , Θⁿ^{ᵥ}^{T}]^{T}, σ(⋅) is a clamping function to impose the constraints

$${a}_{min} \leq {a}_{t} \leq {a}_{max} , {δ}_{min} \leq {δ}_{t} \leq {a}_{max} , {\dot{x}}_{t}^{i} ( \cdot , \cdot ) = {[ {\dot{v}}_{t}^{iT} , {\dot{φ}}_{t}^{i} , {\dot{X}}_{t}^{iT} , {\dot{Y}}_{t}^{iT} ]}^{⊤} ,$$

Δt may be the integration time-step for the discrete dynamics, ωₜ~N(0nₓ×nₓ, Σ_{w}), and Σ_{w}>0nₓ×nₓ.

The cost may be given by:

$${ℓ}_{k} ( {x}_{k} ) = {( {x}_{k}^{0} - {x}^{g} )}^{⊤} Q \text{(*} ) + {u}_{k}^{⊤} {Ru}_{k} + {ℓ}^{pen} ( {x}_{k} ) , \qquad ( 37 a )$$

$$ϕ ( {x}_{t + N} ) = {( {x}_{t + N}^{0} - {x}^{g} )}^{⊤} {Q}_{f} \text{(*} ) + {ℓ}^{pen} ( {x}_{t + N} ) , \qquad ( 37 b )$$

$${ℓ}^{pen} ( {x}_{k} ) = ( {1}^{coll} ( {x}_{k} ) + {1}^{road} ( {x}_{k}^{0} ) + {1}^{inval} ( {x}_{k} ) ) {Q}_{pen} , \qquad ( 37 c )$$

for k={t, t+1, . . . , t+N−1}, where x^{g}=[v^{g}, 0, 0, 0]^{T} may be the goal state, Q=diag(Qᵥ_{_{f}}, Q_{φ}_{_{f}}, Q_{X}_{_{f}}, Q_{Y}_{_{f}})≥0_{nx×nx} is the terminal cost matrix, R|=diag (Rₐ, R_{δ})>0_{nu×nu}, Q_{penalty}∈R may be the violation penalty coefficient, and 1^{coll}(xₖ), 1^{road}(xₖ), 1^{inval}(xₖ) may be the indicator functions for a collision with another vehicle, violating the road boundaries, or an improper merge (not between two vehicles), respectively.

### Traffic Merge Experiment

One may implement the interactive autonomous driving scenario using a variation of the F1-Tenth autonomous vehicle platform, shown in FIG. 5. The vehicles feature onboard may compute using NVIDIA Jetson TX2s for the traffic vehicles and a NVIDIA Jetson Orin Nano for the ego vehicle. The experiments may be carried out in the Georgia Tech Indoor Flight Lab (IFL), which may provide a large open space to act as the “highway” for the merge scenario.

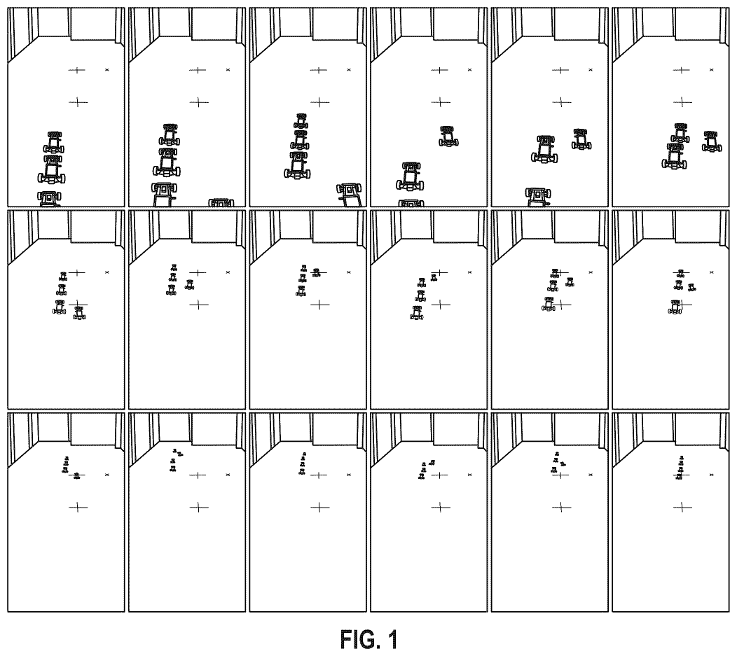

The proposed approach may be compared with two baseline methods: dual model predictive path integral control (DMPPI) and ensemble MPPI (EMPPI) as may be seen in FIG. 1. DMPPI may solve the proposed problem while ablating the multi-modal component of the diffusion solver; that is, it may utilize MPPI as a special case of generative diffusion. EMPPI may additionally ablate the active learning component by utilizing MPPI to solve the above problem. For each method, one may conduct 12 trials featuring different start locations for the ego vehicle relative to the traffic vehicles as well as different variations of traffic vehicle parameters. Importantly, in each trial, only one of the traffic vehicles is “friendly” and will yield to the ego vehicle. Therefore, the ego vehicle should learn the other vehicles' driving behavior parameters in order to find the friendly driver before reaching the end of the merge zone.

Experimental results may be shown in Table I below. The proposed approach and Dual MPPI may both be able to successfully complete the merge in all trials, highlighting the effectiveness of the proposed dual control formulation, which may induce “probing” behaviors. EMPPI, on the other hand, may not feature active learning and so, without probing behaviors, the vehicle may only merge when a gap opens naturally, allowing the vehicle to complete the merge in a purely reactive manner. Moreover, the advantage of the proposed approach over DMPPI may be highlighted by the fact that the proposed approach may be able to complete the merge in less than ⅔ the distance as DMPPI, on average, indicating the proposed approach may be a more efficient solver and may produce better (closer to globally optimal) solutions, which may correspond to faster merge completion (and a lower cost). Finally, the high success rate and faster merging of the proposed approach may be achieved without any type of compromise, as may be shown by the fact that all three methods maintain similar minimum distances from the traffic vehicles.

TABLE I
Experimental results over 12 trials for each method

| | EMPPI | DMPPI | Proposed |
|---|---|---|---|
| Merge Success | 58% | 100% | 100% |
| Rate | | | |
| Ave. Merge | N/A | 7.1 | 4.3 |
| Distance (m) | | | |
| Ave. Min. | 0.53 | 0.52 | 0.53 |
| Distance (m) | | | |
| Ave. Acceleration | 0.04 | 0.05 | 0.07 |
| (m/s²) | | | |

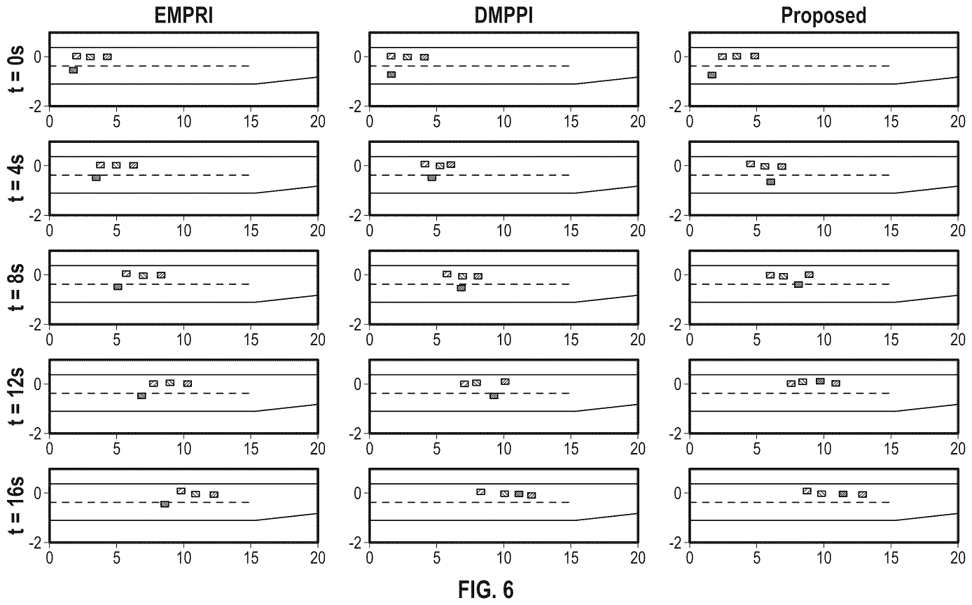

The efficacy of the proposed approach may be further illustrated in FIG. 6, which may give an overview of a single trial for all three methods. In this trial, the ego vehicle may start behind the traffic vehicles and only the green traffic vehicle may yield to the blue ego vehicle. Therefore, the ego vehicle should accelerate to align itself longitudinally with the traffic vehicles and determine which car will yield so that the merge may be completed. As seen in FIG. 6, only the dual control methods may induce the necessary behavior to position the ego vehicle to probe the traffic vehicles. Additionally, the proposed algorithm may be able to open a gap and complete the merge well ahead of DMPPI.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method of active learning to derive predicted belief distributions for autonomous driving, comprising:
providing a control policy to reduce an optimality gap between a model predictive control (MPC) framework and a stochastic MPC framework in formation of the control policy.

2. The method of claim 1, wherein the control policy uses a Bayesian estimation process.

3. The method of claim 1, comprising predicting future belief distributions by conditioning on past observations and planned actions.

4. The method of claim 1, wherein the control policy applied at time t depends on information available at or before time t.

5. The method of claim 1, comprising using a multi-modal diffusion process for receding horizon optimization.

6. The method of claim 5, wherein the multi-modal diffusion process samples from a prior distribution and maps the samples back to a desired distribution.

7. The method of claim 5, wherein the multi-modal diffusion process uses stochastic differential equations (SDE).

8. The method of claim 5, wherein the multi-modal diffusion process uses stochastic differential equations (SDE), wherein a prior distribution is generated by corrupting data samples with noise based on the SDE.

9. The method of claim 8, comprising denoising each prior distribution by reversing the SDE.

10. The method of claim 8, comprising learning a multimodal dynamic prior distribution to reduce a number of steps for denoising each prior distribution, producing Nₘ unique prior distributions.

11. The method of claim 8, comprising learning a multimodal dynamic prior distribution to reduce a number of steps for denoising each prior distribution, wherein denoising each prior distribution is done prior to reaching a fixed prior producing Nₘ unique prior distributions.

12. The method of claim 10, wherein the multimodal dynamic prior distribution uses sampling based approximations to evaluate gradient steps of the denoising.

13. A method of active learning to derive predicted belief distributions for autonomous driving, the method implemented using a computer system including a processor communicatively coupled to a memory device, the method comprising:
designing a control policy to reduce an optimality gap between a model predictive control (MPC) framework and a stochastic MPC framework by using a Bayesian estimation process in the design of the control policy; and
using a multi-modal diffusion process for receding horizon optimization.

14. The method of claim 13, wherein the control policy applied at time t depends on information available at or before time t.

15. The method of claim 13, wherein the multi-modal diffusion process samples from a prior distribution and maps the samples back to a desired distribution.

16. The method of claim 5, wherein the multi-modal diffusion process uses stochastic differential equations (SDE), wherein a prior distribution is generated by corrupting data samples with noise based on the SDE.

17. The method of claim 16, comprising learning a multimodal dynamic prior distribution to reduce a number of steps for denoising each prior distribution, producing Nₘ unique prior distributions.

18. The method of claim 16, comprising learning a multimodal dynamic prior distribution to reduce a number of steps for denoising each prior distribution, wherein denoising each prior distribution is done prior to reaching a fixed prior producing Nₘ unique prior distributions.

19. The method of claim 17, wherein the multimodal dynamic prior distribution uses sampling based approximations to evaluate gradient steps of the denoising.

20. A method of active learning to derive predicted belief distributions for autonomous driving, comprising:
designing a control policy to reduce an optimality gap between a model predictive control (MPC) framework and a stochastic MPC framework by using a Bayesian estimation process in the design of the control policy;
using a multi-modal diffusion process for receding horizon optimization, wherein the multi-modal diffusion process uses stochastic differential equations (SDE), wherein a prior distribution is generated by corrupting data samples with noise based on the SDE; and
learning a multimodal dynamic prior distribution to reduce a number of steps for denoising each prior distribution, wherein denoising each prior distribution is done prior to reaching a fixed prior producing Nₘ unique prior distributions.
